(19) United States
(12) Patent Application Publication
(10) Pub. No.: US 2019/0093628 A1
(43) Pub. Date: Mar. 28, 2019

(54) Vertical axis wind turbine with a telescopic rotational diameter

(71) Applicants: YAN-TING LIN, Taoyuan (TW); YU-CHU LIN, Taoyuan (TW); CHIN-CHENG HUANG, Taoyuan (TW)

(72) Inventors: YAN-TING LIN, Taoyuan (TW); YU-CHU LIN, Taoyuan (TW); CHIN-CHENG HUANG, Taoyuan (TW)

(21) Appl. No.: 15/715,160

(22) Filed: Sep. 26, 2017

(51) Int. Cl. F03D 3/06

(52) U.S. Cl. CPC F03D 3/06; F03D 3/005

(57) ABSTRACT

A vertical axis wind turbine having a varying length of a rotational diameter includes a plurality of vertical blades connected to a central shaft of a generator, the plurality of blades being provided at equal intervals on the outer circumference side of the central shaft, and each of the blades is provided with at least one support shaft member extending towards the central shaft, and in between each of the support shaft member and the central shaft is provided, respectively, with an elastic telescopic assembly, and each of the elastic telescopic assemblies is respectively driven by the centrifugal force of the blades above a rated speed to drive the support shaft member to extend outwardly, so that the rotation radius of each blade from the central shaft increases as the rotational speed increases.

### BACKGROUND OF THE INVENTION

### Field of the Invention

The present invention relates to a vertical axis wind turbine having a varying length of rotational diameter, particularly to a vertical axis wind turbine capable of varying the radius of rotation of the fan blade at different wind speeds.

### Description of Related Art

Because the wind energy characteristics of vertical axis wind turbines are not required for wind direction adjustment, therefore it is particularly suitable for installation in highly turbulent and windy environments. And due to the typical or urban wind field, the low wind speed of fan in the operation, lower than the start of the wind speed, may be caused by turbulence, so that the fan can't run smoothly for power generation. In order to increase the start-up performance, the size of sweep area is usually designed according to the requirements of the use, and the fan is designed as a low solidity value to ensure that the fan can be started at low wind speed. However, in practical applications, the wind field may also encounter instant strong gusts or high-intensity turbulence, resulting in fan speed too fast more than the original design load.

In U.S. Pat. No. 6,972,498, it disclosed features of changing the continuous geometrical variation of the blade into a variable multi-stage telescopic form. However, in practical applications, the above structure will cause structural vibration due to significant changes in aerodynamic force.

In U.S. Pat. No. 8,459,937, it disclosed that the use of an active hydraulic mechanism to control the scissor-type link mechanism to change the radius of the fan, but the design has drawbacks that an external power required for the operation of the hydraulic press needs to be provided, and the scissors of the link mechanism in the operation will also cause aerodynamic drag.

In WO 2005017351, a technical means changing the radius of the fan blade at varying wind speeds is disclosed; however, such a structure will cause the discontinuous surface of the wake effect and form aerodynamic noise.

In US 20140167414, it disclosed a mechanism to operate the turbine blade in compact under high wind speed In order to achieve the destruction of aerodynamic flow and reduce the speed effect of turbine blade. But its overall design is extremely complex and difficult in aerodynamic design.

In WO 2013114402, it disclosed a technical feature of changing the radius of rotation of the vertical shaft blade by means of a screw mechanism; however, it can only be operated beforehand, and the blade is operated under a fixed radius of rotation and the radius of rotation of the blade can't be adjusted automatically when the blade is running.

In addition, the article “Design of a vertical-axis wind turbine” in the journal “International Journal of Energy and Environmental Engineering” published on Aug. 2, 2014, disclosed that the vertical axis blade of a flat structure may provide more power generation and better conversion efficiency if the structure can be made in a slim type.

To overcome the shortcomings, the present invention tends to provide an improved vertical axis wind turbine to mitigate and obviate the mentioned above problems.

### SUMMARY OF THE INVENTION

The primary object of the present invention is to provide a vertical axis wind turbine capable of increasing a rotational diameter which is provided with at least one support shaft member on each blade facing the central shaft of a vertical axis wind turbine, an elastic telescopic assembly which is respectively provided between the support shaft member and the central shaft, and the centrifugal force generated by the operation of the blades at the rated speed exerting on the elastic telescopic assembly to drive the support shaft member to extend its length as the blade rotation speed increases, increasing the rotation radius of each blade from the central shaft. Based on the principle of conservation of angular momentum, increasing the radius of rotation will cause the speed to decrease, so that the change of the efficiency of the wind turbine can be deteriorated by the change of the aerodynamic force, thus avoid the damage to the wind turbine caused by high speed operation of the blade, maintaining the stable speed and output power.

Another object of the present invention is to provide a vertical axis wind turbine capable of increasing the rotational diameter which increases the overall shape of the vertical axis wind turbine after the increase in the radius of rotation of each blade, thereby improving the wind energy conversion efficiency, In the process of reducing rotational speed and the amount of electric power due to increase in the rotational diameter and gust, the power generation efficiency may be compensated for by the flattened structure design to further stabilize the power generation.

In order to achieve the above objects, the technical features of the present invention comprises a central shaft extending vertically and connected at one end to a generator, a plurality of blades arranged at equal intervals on the outer peripheral side of the central shaft, the plurality of support shaft members are respectively bonded to each of the blades at one end, and the other end of each of the support shaft members is extended towards the central shaft, the plurality of elastic telescopic assemblies are furnished at equal intervals on the outer peripheral side of the central shaft, and each of the elastic telescopic assemblies is connected to one end of each of the support shaft members remote from each of the blades, and each of the elastic telescopic assemblies drives the support shaft members to produce a stretch through rotation of each blade centrifugal force, and the rotation radius of each blade from the central shaft increases as the rotational speed increases, and when the centrifugal force decreases due to the decrease of the rotation speed of the blade, the respective support shaft members automatically return to the original position.

According to the above-mentioned structure, each of the elastic telescopic assemblies has an outer sleeve, and each of the outer sleeves is spaced apart and radially disposed on the outer peripheral side of the central shaft, and each of the outer sleeves is provided with an axial reciprocating an active piston and an elastic member connected to each end of the support shaft member remote from each of the blades, the elastic element being abutted against the piston at one end and the other end of the elastic member being abutted against the outer sleeve at the inner side towards each blade.

According to the above-mentioned structure, in which the support shaft member is a support shaft having a fixed length.

According to the above-mentioned structure, in which a damping element is provided in the outer sleeve on the side of the piston towards the central shaft, the damping element can form a hysteresis effect on the movement of the piston.

According to the above-mentioned structure, each of the support shaft members has an inner sleeve, each of which extends into the outer sleeve at one end and is connected to each piston, and the other end of each inner sleeve extends to the outside of the outer sleeve, and the inner piston is provided with an inner piston and an inner elastic member which are reciprocally movable in the inner sleeve, and the inner piston is connected to each blade via a support shaft, and the inner elastic member is arranged at one end, and the other end of the inner elastic member abuts against the inner side of the inner sleeve towards the inner side of each blade.

According to the above-mentioned structure, in which an inner damping member is provided on the side of the inner sleeve towards the piston, the inner damping element can form a hysteresis effect on the movement of the inner piston.

The above and other objects, features and advantages of the present invention will become apparent from the following detailed description taken with the accompanying drawings.

### BRIEF DESCRIPTION OF THE DRAWINGS

FIG. 1 is a perspective view of a three-dimensional structure of the first embodiment of the present invention.

FIG. 2 is a plan view and a partial cross-sectional view of the first embodiment of the present invention.

FIG. 3 is a schematic view showing a change in the radius of rotation of the first embodiment of the present invention.

FIG. 4 is a plan view and a partial cross-sectional view of a second embodiment of the present invention.

FIG. 5 is a schematic view showing a change in the radius of rotation of the second embodiment of the present invention.

### DETAILED DESCRIPTION OF THE PREFERRED EMBODIMENTS

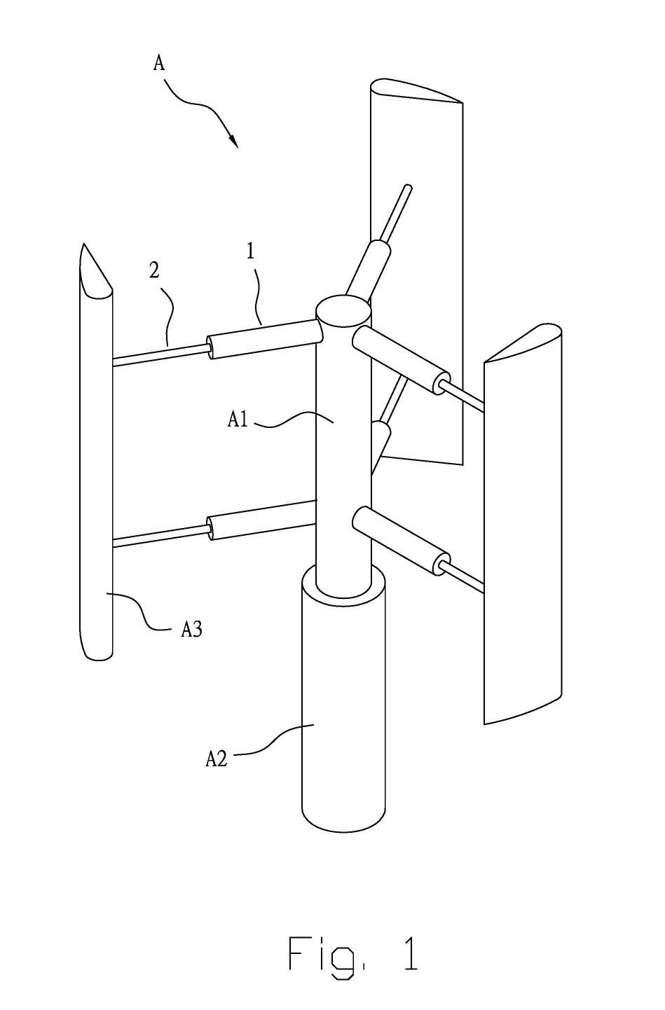

As shown in FIGS. 1 to 3, it can be understood that the main structure of the first embodiment of the present invention comprises a plurality of elastic telescopic assemblies 1 and a plurality of support shaft members 2, in which the elastic telescopic assemblies 1 are furnished at equal intervals on the outer peripheral side of a center shaft A1 which is connected to a generator A2 at one end, and a plurality of blades A3 are provided on the outer peripheral side of the center shaft A1, and the plurality of support shaft members 2 are respectively connected at one end on the blades A3, and the other ends of the respective support shaft members 2 are connected to the elastic telescopic assemblies 1.

When the blades A3 are rotated to a rated rotational speed or greater, the centrifugal force is generated by the respective support shaft members 2 to exert on each of the elastic telescopic assemblies 1, so that each of the elastic telescopic assemblies 1 drives the respective support shaft members 2 to produce a length change in the radius of rotation of each blade A3, the greater the rotational speed of each blade A3, the larger the centrifugal force acting on each elastic telescopic assembly 1, resulting in the longer the extension length of each of the support shaft members 2 and the longer the rotation radius of each blade A3.

Based on the principle of conservation of angular momentum, the rotation speed of each blade A3 is reduced when rotation speed reaches at a certain speed, whereby it is to effectively avoid the situation where the rotation speed of each blade A3 exceeding the original design load due to the instantaneous strong gust or high-intensity turbulence and stabilize the speed of the blade A3 speed and output power; and when the rotation speed of the blade A3 is reduced and causing the centrifugal force to decrease, each of the elastic telescopic assemblies 1 can drive the respective support shaft members 2 to gradually retract and recover to produce a higher value in solidity with a shorter radius of rotation that favors the start up in the breeze.

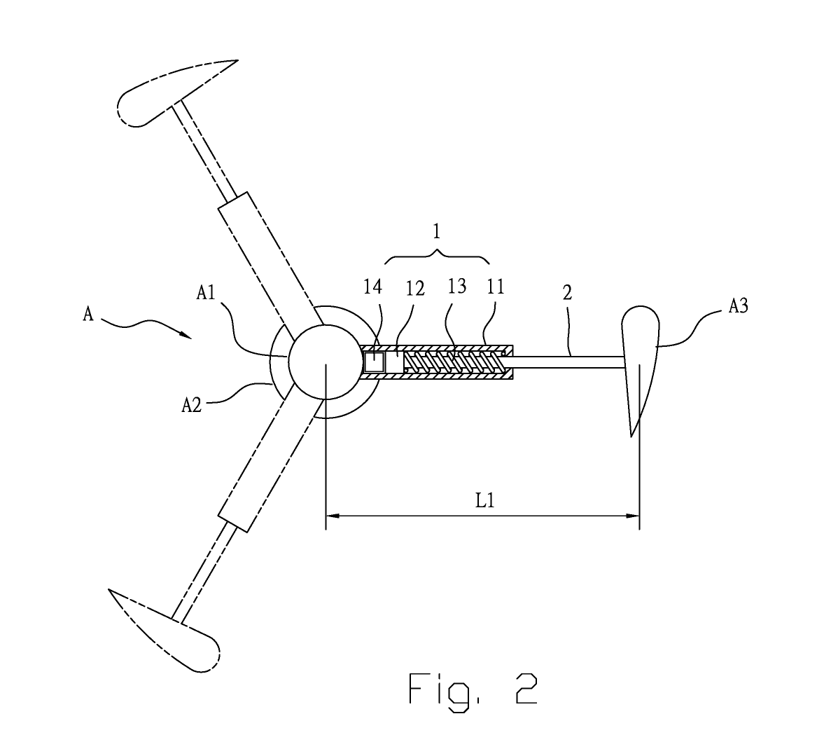

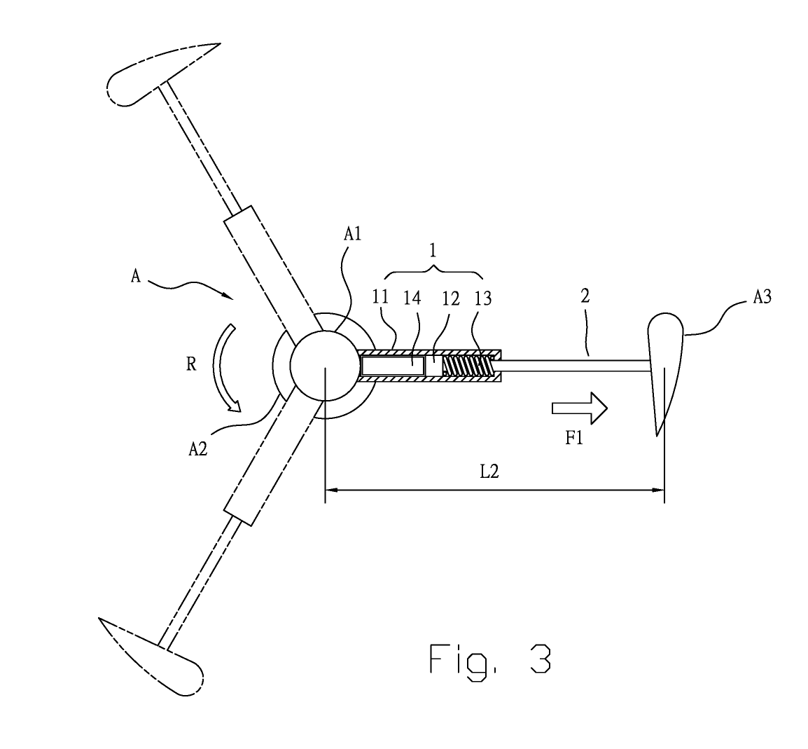

In one preferred embodiment of the present invention, each of the elastic telescopic assemblies 1 has an outer sleeve 11, which are equally spaced and radially disposed on the outer peripheral side of the central shaft A1, and inside each of the outer sleeve 11, a piston 12 and a elastic element 13 which are axially reciprocally movable are provided respectively; and the support shaft member 2 is a single shaft having a fixed length which extends at one end remote from each blade A3 into the outer sleeve 11 and is connected to the piston 12, and the elastic member 13 having one end abutting against the piston 12 and the other end of the elastic element 13 is fixed at the end inside the outer sleeve 11 towards one side of each blade A3, and a damping element 14 may be provided between the piston 12 and the central shaft A1 in the outer sleeve 11, which may form a hysteresis effect on the movement of the piston 12 as shown in FIGS. 2 and 3.

In the initial state, the support shaft member 2 can be fitted into the outer sleeve 11 by the elastic support of the elastic member 13 so that the original length L1 between the blades A3 and the central shaft A1 is maintained after the blades A3 are rotated at a constant rotational speed, and when the centrifugal force F1 produced by the blades A3 exerted to the elastic telescopic assemblies 1 generates an extension of the elastic member 13 via the support shaft member 2 is occurred, the length L2 after extension between each blade A3 and the central shaft A1 becomes greater than the original length L1.

In practical application, when the rotational speed of each blade A3 is kept below the rated rotational speed, it does not generate sufficient centrifugal force F1 to compress the elastic element 13, the original length L1 between each blade A3 and the central shaft A1 can produce a higher solidity in order to facilitate the start up in the breeze and maintain the rated output power with enough wind.

The large centrifugal force F1 generated by each blade A3 is applied to each of the elastic telescopic assemblies 1 via the respective shaft members 2 and compresses the elastic members 13 when the high temperature of the blades A3 is caused to rotate at high speed in the case of strong gusts or high intensity turbulence, and the support shaft member 2 extends outwardly of the elastic telescopic assembly 1. Based on the conservation principle of the angular momentum, the longer rotational radius will reduce the rotational speed of each blade A3, so that when the external wind speed exceeds the preset rating, the longer length L2 will decrease the rotational speed of each blade A3 and effectively avoid the occasional strong gusts or high-intensity turbulence caused by the blade A3 speed which is too fast and exceeds the original design load; however, when the rotational radius of each blade A3 is increased, the structure of the wind turbine is also become flattened, so that the wind turbine has a better aerodynamic efficiency to compensate for the decrease in the power generation power due to the decrease in the rotational speed of each blade A3. It is therefore effective to maintain a stable speed and output power.

And when the external wind force is reduced below the rated value, the driving force of the blade A3 is reduced causing the centrifugal force F1 to be reduced to compress the elastic member 13, and each of the elastic members 13 and the support shaft member 2 are completely retracted in the outer sleeve 11 so that the length between respective blades A3 and the central shaft A1 can be returned to the original length L1.

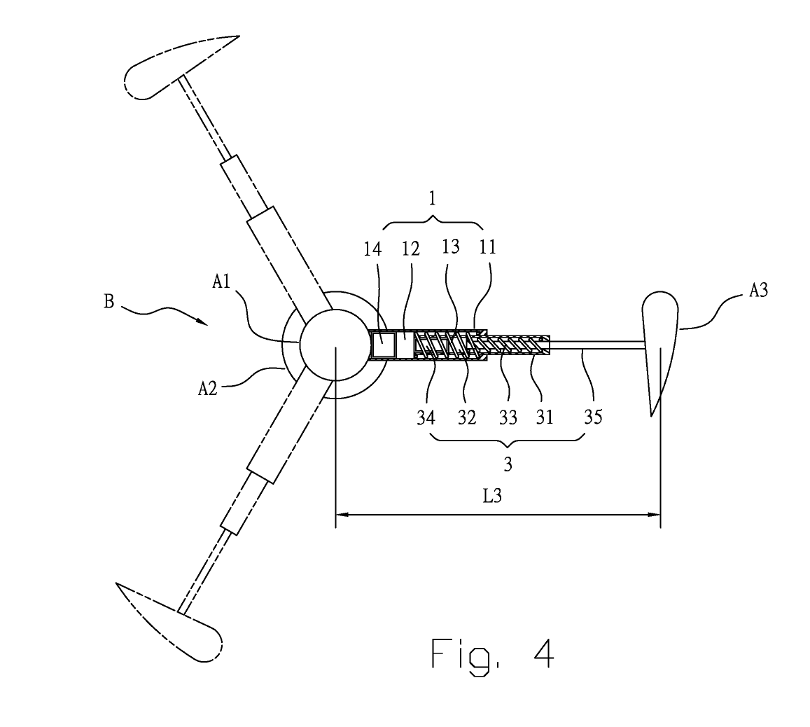

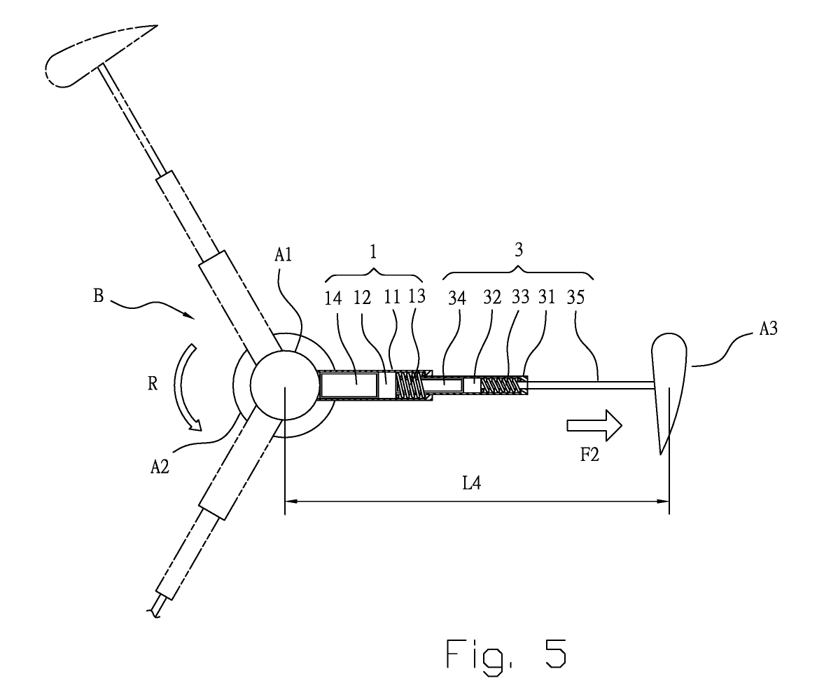

As shown in FIGS. 4 to 5, the main structure of the second embodiment of the present invention comprises a plurality of support shaft members 3 and a plurality of elastic telescopic assemblies 1 as in the foregoing first embodiment, wherein the elastic telescopic assemblies 1 are arranged at equal intervals on the outer peripheral side of the central shaft A1 extending vertically upright on a vertical axis wind turbine B, and the central shaft A1 is connected at one end to a generator A2, and the outer peripheral side of the central shaft A1 is provided with a plurality of blades A3, each of which has an inner sleeve 31 which extends at one end into the outer sleeve 11 and is connected to each piston 12, and the other end of each inner sleeve 31 extends beyond the outer sleeve 11, and an inner piston 32 and an inner elastic member 33, which are reciprocally movable in the inner sleeve 31 are provided, respectively, and the inner piston 32 Is connected to each of the blades A3 via a support shaft member 35 which abuts against the inner piston 32 at one end and the other end of the inner elastic member 33 abuts against the inner sleeve 31 towards one of the blades A3, and an inner damping member 34 may be provided between the inner piston 32 and the piston 12 in the inner sleeve 31. The inner damping member 34 may form a hysteresis effect on the movement of the inner piston 32. As shown in FIGS. 4 and 5.

The inner sleeve 31 can be fitted into the outer sleeve 11 by the elastic support of the elastic member 13 and the inner elastic member 33 in the initial state, and the support shaft members 35 is engaged with the inner sleeve 31 having an original length L3 between the blades A3 and the central shaft A1. When the blades A3 are rotated to a certain rotational speed, the centrifugal force F2 produced by the blades A3 can be exerted at the respective support shaft members 3 to compress the inner elastic members 33 via the support shafts assemblies 35 and the elastic member 13 via the elastic telescopic assemblies 1, and at this time, there is an extended length L4 greater than the original length L3 between each blade A3 and the central shaft A1.

In the structure described above, it is also possible to use the support shaft members 3 and the elastic telescopic assembly 1, which can be simultaneously telescoped to provide greater extension and contraction range of the blades A3 in comparison with that of the first embodiment. The elastic member 13 and the inner elastic member 33 are designed to have different elastic coefficients so that each blade A3 has an elastic stretching property corresponding to the action of the different centrifugal force F2 to satisfy the demand difference in various occasions.

The main features of the present invention are as follows:

1. The exploitation of passive mode design, no external power supply and control system required, not only low cost, and the overall structure is relatively simple and less fault in operation to ensure better product quality.

2. Using the self-weight centrifugal force of the blade to drive, it is easy to estimate the centrifugal load quickly by the designed rated speed and the blade weight and choose the matching spring elements. The complete design of the present invention is of great simplicity and saves the time.

3. When the blade speed is below the rated value, the centrifugal force produced by the rotation of the blade is not sufficient to actuate the elastic telescopic assembly, which keeps the radius of rotation of the blade the shortest and the maximum number of SOLIDITY, not only for the startup in the breeze, but also to maintain the rated speed at rated wind speed, where the the solidity is defined by the ratio of the blade sectional length and swivel circumference length. SOLIDITY=N*L/(Pl*D), wherein N: number of blade: L: blade chord length; Pl: circumferential ratio; D: diameter.

4. The overall centrifugal force can be calculated by F=m*r*w², wherein F: centrifugal force; r: rotation radius; w: angular speed, when the blade is affected by the momentary strong gust, and the appropriate elastic element can be selected to absorb the centrifugal force. For an elastic element after compression and balance, the rotation radius of the blade can be increased, and the blade will decrease the rotational speed under the conservation principle of the angular momentum, m*r*Vt=constant, wherein m: mass; r: rotation radius; Vt: tangential speed of blade, so as to avoid the generator damage caused by the high blade speed.

5. At the same time as the blade speed decreased, the overall radius of the wind turbine is flattened due to the increase in the radius of rotation at the instant, so that the sweep area can be increased to gain the wind energy acquisition in kW and improve the wind energy conversion efficiency Cp, compensating the decline in power generation caused by the decreased speed to maintain a stable power output.

6. When the wind gust is over, the wind speed returns below the rated value, the blade rotation is down below the rated speed, the rotation of the blade produced by the centrifugal force is not enough to compress the elastic element, so that the blade rotation radius automatically restored to original designed length.

Therefore, the technical features of the present invention can be exploited to increase the rotation diameter of the vertical shaft of the wind turbine under different wind speed by means of changing the radius of the blade rotation of the vertical shaft to maintain the stability of the speed and output power. However, the above descriptions is only the preferred embodiment of the invention, any change, modification, variation or equivalent replacement according to this invention should all fall within what is claimed of this invention.

What is claimed is:

1. A vertical axis wind turbine with a varying length of rotational diameter, comprising at least a central shaft extending vertically, connected at one end to a generator, a plurality of blades arranged at equal intervals on the outer peripheral side of the central shaft, a plurality of support shaft members are connected to each blade at one end, respectively, and extended towards the central shaft at the other end, a plurality of elastic telescopic assemblies are respectively provided at equal intervals on the outer peripheral side of the central shaft, wherein each of the elastic telescopic assemblies is connected to the support shaft member at one end remote from each of the blades, wherein each of the elastic telescopic assemblies is driven by a centrifugal force generated by the rotation of each blade to produce the extension of the support shaft member so that the rotation radius of each blade from the central shaft increases as the rotation speed increases, and the centrifugal force is reduced as the rotation speed of the blade decreases, resulting in that the support shaft components automatically gradually return to the original position.

2. The vertical axis wind turbine with a varying length of rotational diameter as set forth in claim 1, wherein each of the elastic telescopic assemblies has an outer sleeve and each outer sleeve is arranged at equal interval and radially provided on the outer peripheral side of the central shaft, wherein a piston and an elastic member are provided and reciprocally movable in the outer sleeve, wherein the piston is attached to one end of the respective support shaft member remote from each of the blades, wherein the elastic member is abutted against the piston at one end and the other end is abutted against the inside of the outer sleeve towards one side of the blade facing inward.

3. The vertical axis wind turbine having a varying length of rotational diameter as set forth in claim 2, wherein the support shaft member is of a fixed length.

4. The vertical axis wind turbine having a varying length of rotational diameter as set forth in claim 2, wherein a damping element is provided on the side of the outer sleeve towards the center shaft, and the damping element is provided to form a hysteresis effect on the movement of the piston.

5. The vertical axis wind turbine having a varying length of rotational diameter as set forth in claim 2, wherein each of the support shaft members has an inner sleeve, each inner sleeve extending into the outer sleeve at one end and connected to the piston, and the other end of each inner sleeve extends beyond the outer sleeve, wherein an inner piston and an inner elastic member are axially reciprocally provided in each inner sleeve, respectively, wherein the inner piston is connected to each of the blades via the support shaft member, wherein the inner elastic member is abutted against the inner piston and the other end of the inner elastic member is abutted against the inner side of the inner sleeve towards each side of the blades facing inward.

6. The vertical axis wind turbine having a varying length of rotational diameter as set forth in claim 5, wherein an inner damping member is provided in the inner sleeve on one side facing the inner piston, wherein an inner damping element is provided to form a hysteresis effect on the movement of the inner piston.
